(19) United States
(12) Patent Application Publication
(10) Pub. No.: US 2014/0104021 A1
(43) Pub. Date: Apr. 17, 2014

(54) System and Method for Demagnetization of a Magnetic Structure Region

(71) Applicant: Correlated Magnetics Research, LLC., New Hope, AL (US)

(72) Inventors: Larry W. Fullerton, New Hope, AL (US); Mark D. Roberts, Huntsville, AL (US); Hamilton Grant Moore, Decatur, AL (US)

(73) Assignee: Correlated Magnetics Research, LLC., New Hope, AL (US)

(21) Appl. No.: 14/052,891

(22) Filed: Oct. 14, 2013

Related U.S. Application Data
(60) Provisional application No. 61/795,352, filed on Oct. 15, 2012.

(51) Int. Cl. H01F 13/00

(52) U.S. Cl. CPC H01F 13/006
USPC 335/284

(57) ABSTRACT

A system and a method are described herein for demagnetizing a region of a magnetic structure. In one embodiment, the system comprises: (a) a pulsed magnetizer; and (b) at least one magnetizing coil that receives a sequence of discrete currents with continually decreasing current values from the pulsed magnetizer and outputs a sequence of discrete magnetizing fields with continually decreasing field strengths to overwrite and at least partly demagnetize the region of the magnetic structure. The at least one magnetizing coil is located adjacent to the region of the magnetic structure.

### CLAIM OF PRIORITY

This application claims the benefit U.S. Provisional Application Ser. No. 61/795,352 filed on Oct. 15, 2012. The contents of this document are incorporated by reference herein.

### FIELD OF THE INVENTION

The present invention relates generally to a system and method for demagnetization of a magnetic structure region. More particularly, the present invention relates to demagnetization of a magnetic structure region by magnetically overwriting alternating polarity maxels having decreasing field strengths.

### BACKGROUND OF THE INVENTION

The demagnetization or removal of a magnetic field may be accomplished in several ways as described at http://www.ndt-ed.org/EducationResources/CommunityCollege/MagParticle/Physics/Demagnetization.htm, on Oct. 12, 2012, which is incorporated by reference herein. One demagnetization approach is to heat a material above its Curie temperature to produce a random orientation of the magnetic domains, which demagnetizes the material. Another demagnetization approach is to subject the material to a reversing and decreasing magnetic field produced by driving a (de)magnetizer with a decreasing alternating current. This AC demagnetization process, shown in FIG. 1 (PRIOR ART), can be accomplished by pulling a component out and away from a coil with AC passing through it. The same can also be accomplished using an electromagnetic yoke with AC selected. Also, many stationary magnetic particle inspection units come with a demagnetization feature that slowly reduces the AC in a coil in which the component is placed. As can be seen in FIG. 1 (PRIOR ART), which depicts a demagnetization hysteresis curve 102, the current passing through a magnetizing coil decreases in accordance with an alternating current having a current curve 104. The demagnetizing field of the magnetizing coil corresponds to a flux curve 106 that corresponds to the current curve 104, where the alternating polarity H field that is produced by the coil results in a smaller and smaller B field being present in the material inside the coil. An alternative demagnetization approach is the subject of the present invention.

### SUMMARY

A system and method for demagnetizing a region of a magnetic structure are described in the independent claims of the present application. Advantageous embodiments of the system and method have been described in the dependent claims of the present application.

In one aspect, the present invention provides a system for demagnetizing a region of a magnetic structure. The system comprises a pulsed magnetizer and at least one magnetizing coil. The at least one magnetizing coil receives a sequence of discrete currents with continually decreasing current values from the pulsed magnetizer and outputs a sequence of discrete magnetizing fields with continually decreasing field strengths to overwrite and at least partly demagnetize the region of the magnetic structure. The at least one magnetizing coil is located adjacent to the region of the magnetic structure.

In another aspect, the present invention provides a method for demagnetizing a region of a magnetic structure. The method comprises: (a) generating, by a pulsed magnetizer, a sequence of discrete currents with continually decreasing current values; (b) receiving, by at least one magnetizing coil, the sequence of discrete currents with continually decreasing current values; and (3) outputting, by the at least one magnetizing coil, a sequence of discrete magnetizing fields with continually decreasing field strengths to overwrite and at least partly demagnetize the region of the magnetic structure. The at least one magnetizing coil is located adjacent to the region of the magnetic structure.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 (PRIOR ART) is a graph used to help explain a traditional AC demagnetization process for demagnetizing a magnetic structure;

FIG. 2 is a graph used to help explain a new demagnetization process for demagnetizing a magnetic structure in accordance with an embodiment of the present invention;

FIGS. 3A-3D illustrate an exemplary demagnetization process for demagnetizing a region (i.e., outer edge or outer perimeter) on a magnetic structure in accordance with an embodiment of the present invention;

FIG. 4 is a flowchart illustrating an exemplary demagnetization method in accordance with an embodiment of the present invention;

FIG. 5 is a flowchart illustrating another exemplary demagnetization method in accordance with an embodiment of the present invention; and

FIG. 6 is a flowchart illustrating yet another exemplary demagnetization method in accordance with an embodiment of the present invention.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in the art.

The present invention pertains to a system and method for demagnetization of a magnetic structure region. Certain described embodiments may relate, by way of example but not limitation, to systems and/or apparatuses comprising magnetic structures, methods for using magnetic structures, magnetic structures produced via magnetic printing, magnetic structures comprising arrays of discrete magnetic elements, combinations thereof, and so forth. Example realizations for such embodiments may be facilitated, at least in part, by the use of an emerging, revolutionary technology that may be termed correlated magnetics. This revolutionary technology referred to herein as correlated magnetics was first fully described and enabled in the co-assigned U.S. Pat. No. 7,800,471 issued on Sep. 21, 2010, and entitled “A Field Emission System and Method”. The contents of this document are hereby incorporated herein by reference. A second generation of a correlated magnetic technology is described and enabled in the co-assigned U.S. Pat. No. 7,868,721 issued on Jan. 11, 2011, and entitled “A Field Emission System and Method”. The contents of this document are hereby incorporated herein by reference. A third generation of a correlated magnetic technology is described and enabled in the co-assigned U.S. patent application Ser. No. 12/476,952 filed on Jun. 2, 2009, and entitled “A Field Emission System and Method”. The contents of this document are hereby incorporated herein by reference. Another technology known as correlated inductance, which is related to correlated magnetics, has been described and enabled in the co-assigned U.S. Pat. No. 8,115,581 issued on Feb. 14, 2012, and entitled “A System and Method for Producing an Electric Pulse”. The contents of this document are hereby incorporated by reference.

Material presented herein may relate to and/or be implemented in conjunction with multilevel correlated magnetic systems and methods for producing a multilevel correlated magnetic system such as described in U.S. Pat. No. 7,982,568 issued Jul. 19, 2011 which is all incorporated herein by reference in its entirety. Material presented herein may relate to and/or be implemented in conjunction with energy generation systems and methods such as described in U.S. patent application Ser. No. 12/895,589 filed Sep. 30, 2010, which is all incorporated herein by reference in its entirety. Such systems and methods described in U.S. Pat. No. 7,681,256 issued Mar. 23, 2010, U.S. Pat. No. 7,750,781 issued Jul. 6, 2010, U.S. Pat. No. 7,755,462 issued Jul. 13, 2010, U.S. Pat. No. 7,812,698 issued Oct. 12, 2010, U.S. Pat. Nos. 7,817,002, 7,817,003, 7,817,004, 7,817,005, and 7,817,006 issued Oct. 19, 2010, U.S. Pat. No. 7,821,367 issued Oct. 26, 2010, U.S. Pat. No. 7,823,300 and U.S. Pat. No. 7,824,083 issued Nov. 2, 2011, U.S. Pat. No. 7,834,729 issued Nov. 16, 2011, U.S. Pat. No. 7,839,247 issued Nov. 23, 2010, U.S. Pat. Nos. 7,843,295, 7,843,296, and 7,843,297 issued Nov. 30, 2010, U.S. Pat. No. 7,893,803 issued Feb. 22, 2011, U.S. Pat. No. 7,956,711 and U.S. Pat. No. 7,956,712 issued Jun. 7, 2011, U.S. Pat. Nos. 7,958,575, 7,961,068 and 7,961,069 issued Jun. 14, 2011, U.S. Pat. No. 7,963,818 issued Jun. 21, 2011, and U.S. Pat. No. 8,015,752 and U.S. Pat. No. 8,016,330 issued Sep. 13, 2011, and U.S. Pat. No. 8,035,260 issued Oct. 11, 2011 are all incorporated by reference herein in their entirety.

Various methods for printing maxels are described in U.S. Parent application Ser. No. 13/240,355, field Sep. 22, 2011 and titled Magnetic Structure Production, which is incorporated by reference herein it its entirety.

In accordance with the present invention, a region of a magnetic structure is demagnetized (or erased) by successive overwriting of the region with magnetic sources having alternating polarities and decreasing field strengths. More specifically, the magnetic field sources, which are often called maxels, are produced using a pulsed magnetizer where a very short current pulse is passed through a magnetizing coil located adjacent to a location on the surface of a magnetizable material. Each maxel has a size, shape, depth, polarity, field strength, angle relative to the magnetization surface, and various other maxel characteristics that are in accordance with material characteristics such as material type (e.g., NIB), grade, thickness, shape (e.g., flat), etc., magnetizing coil characteristics such as metal type, layer thickness, number of turns, aperture width, coil width, coil shape, aperture shape, etc., and magnetizing characteristics such as the amount of current passed through the coil, and the direction of the current through the coil, distance between the coil and the surface, angle of the coil relative to the surface, etc., where one skilled in the art will understand that any of these magnetizing coil characteristics and/or magnetizing characteristics can be varied to effect demagnetization in accordance with the invention. As such, one or more magnetizer coils having the same or different magnetizing coil characteristics can be used with the same or different magnetizing characteristics to overwrite and demagnetize one or more regions on one or more magnetic structures.

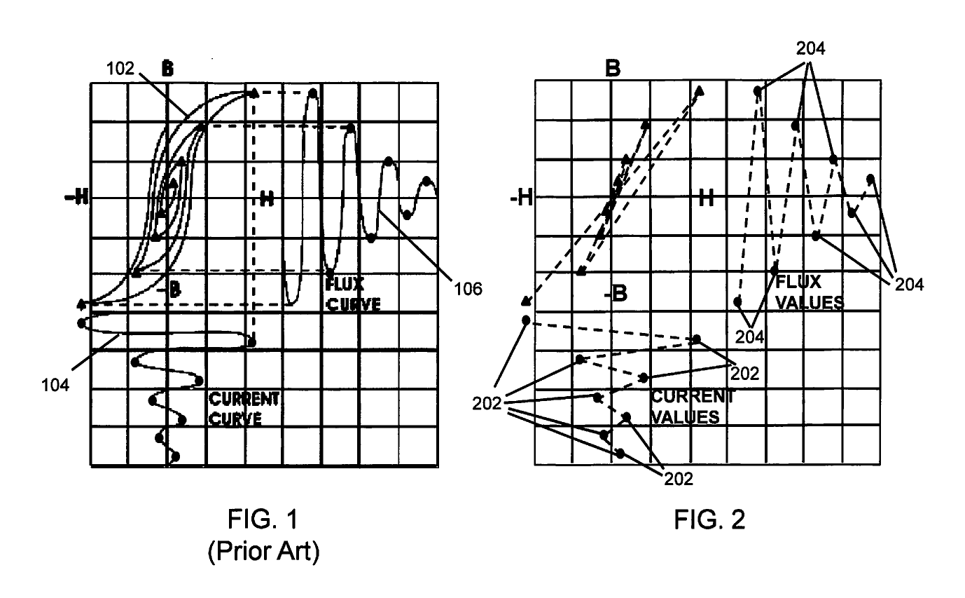

FIG. 2 depicts exemplary discreet current values 202 of current used to drive a magnetizer coil in order to produce (or write) overwrite alternating polarity maxels at a given location on a material, where each discreet current value 202 has a corresponding discreet flux value 204 of magnetic flux produced by the magnetizer coil. As shown, the current values 202 used to drive the magnetizer coil change polarity and decrease with each printed maxel to produce a sequence of alternating polarity maxels with decreased field strength in order to demagnetize the location on the material. The discrete current values 202 and flux values 204, for example, correspond to the peak current and peak flux values of the current and flux curves 104 and 106 of FIG. 1. However, the discrete current values 202 can decrease in accordance with some other desired decrement pattern such as a uniform decrement pattern. Generally, the starting discrete current value 202 of a demagnetization process can be selected based on the field strength of the region of the magnetic structure as determined prior to demagnetization. For example, a measurement of the field to be erased could be made, and a current value 202 could be selected such that the starting demagnetizing magnetic field would be of opposite polarity of the field being erased and somewhat lower in field strength. However, an alternate approach would be to select a starting current value 202 based on material characteristics that will result in a near saturating field. However, if only partial demagnetization is desired, the starting demagnetizing field may be selected that is substantially lower than the field strength of the region of the magnetic structure prior to demagnetization.

Because the printing of each maxel is substantially a discreet event as opposed to demagnetization using a continuous alternating current, all sorts of combinations are possible for demagnetizing a region on a magnetic structure including use of multiple print heads to demagnetize one or more regions on one or more magnetic structures, where characteristics of a given print head and the use of such print head can be controlled to control the demagnetization process. For example, one or more print heads can be used to demagnetize a region on a magnetic structure, where the location of at least one print head is fixed. Alternatively, one or more movable print heads may be used. Combinations of different print head sizes (e.g., aperture diameters), maxel shapes, maxel depths, and the like can be used. Many patterning choices are available such as maxel print order, the amount of overlapping of maxels (or spatial density), the spacing between maxels, etc. Moreover, instead of alternating polarity with each overwriting maxel, multiple maxels of the same polarity may overwrite successively. In other words, a region may be overwritten one or more times with a magnetizing field having the same polarity before being overwritten one or more times with a magnetizing field having the opposite polarity. Generally, one skilled in the art will recognize that all sorts of variations of the invention are possible.

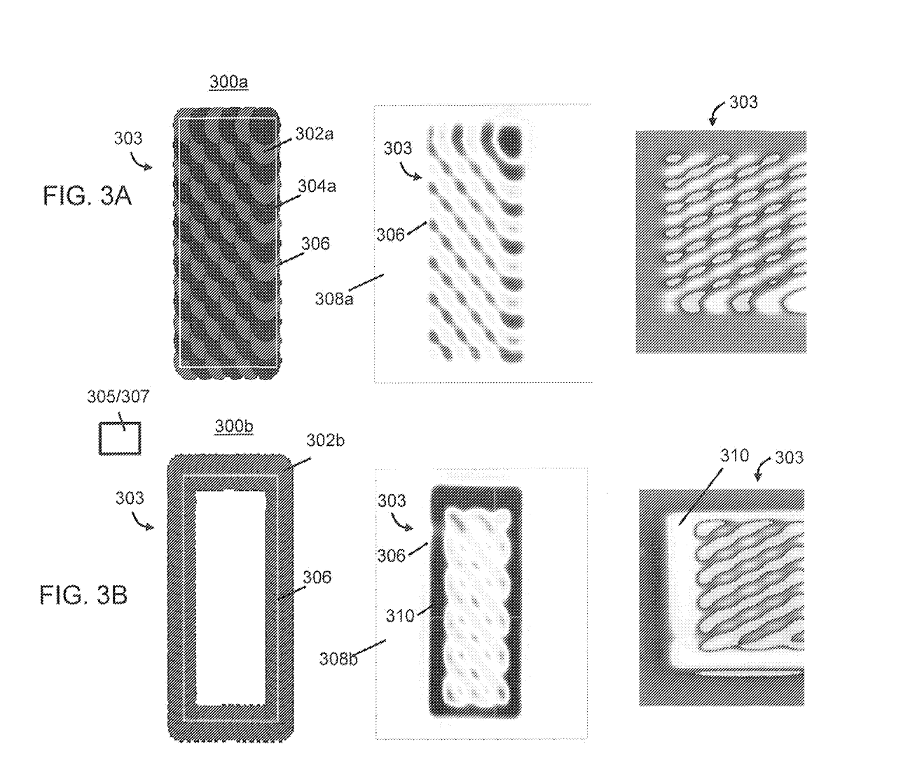

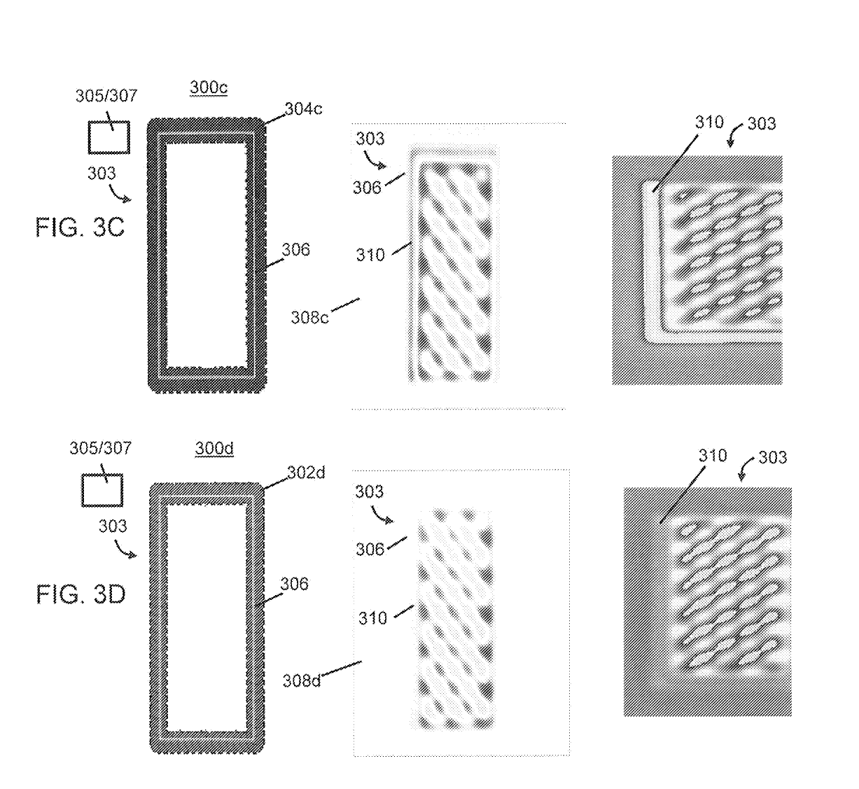

FIGS. 3A through 3D are provided to illustrate an exemplary demagnetization process for demagnetizing a region 306 on a magnetic structure 303 corresponding to its outer boundary (i.e., outer edge or outer perimeter). Referring to FIG. 3A, a first maxel pattern 300a of first polarity maxels 302a and second polarity maxels 304a have been printed onto a magnetizable material 303 having an outer boundary 306. The maxels 302a and 304a have been printed in columns from the bottom of the magnetizable material 303 to the top of the magnetizable material 303 and from the left side to the right. As such, the first maxel printed is in the lower left corner and the last maxel printed is in the upper right corner. A field scan 308a shows the resulting magnetic field, where the outer boundary 306 of the magnetizable material 303 is shown. FIG. 3B shows a second maxel pattern 300b comprising overlapping first polarity maxels 302b having a first field strength that are printed by magnetizing coils 305 (and a pulsed magnetizer 307) along the outer boundary 306, which corresponds to a demagnetization region 310 on the magnetizable material 303. The resulting field scan 308b shows the outer boundary 306 and demagnetization region 310 of the magnetizable material 303. In FIG. 3C, a third maxel pattern 300c comprising overlapping second polarity maxels 304c having a second field strength less than the first field strength that are printed by magnetizing coils 305 (and a pulsed magnetizer 307) along the outer boundary 306, which corresponds to a demagnetization region 310c on the magnetizable material 303. As seen in the field scan 308c of FIG. 3C, the demagnetization region 310c is becoming more and more demagnetized on the magnetizable material 303. In FIG. 3D, a fourth maxel pattern 300d comprising overlapping first polarity maxels 302d having a third field strength that are printed by magnetizing coils 305 (and a pulsed magnetizer 307) along the outer boundary 306, which corresponds to a demagnetization region 310c on the magnetizable material 303. As seen in the field scan 308d of FIG. 3D, the demagnetization region 310 is substantially demagnetized on the magnetizable material 303.

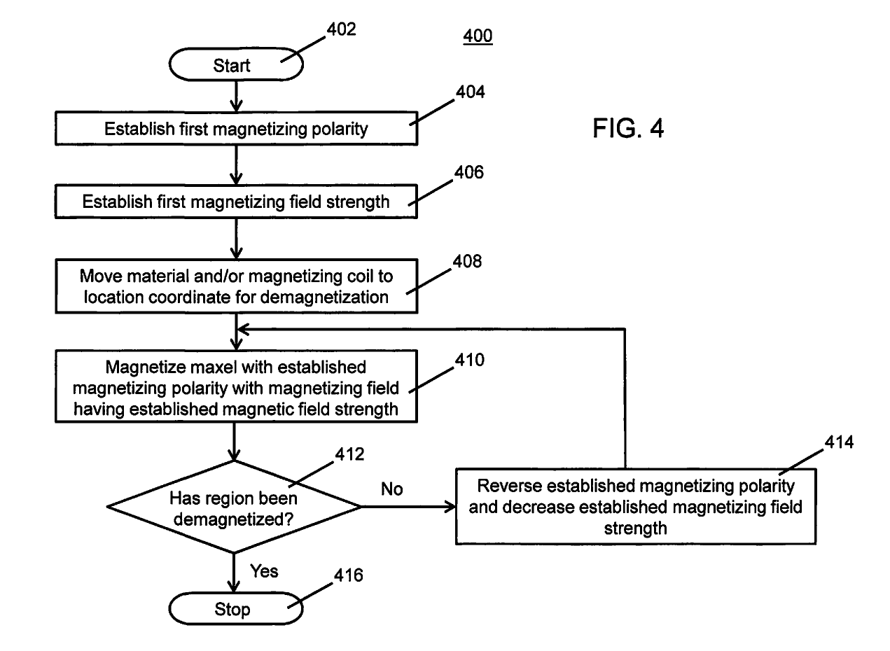

In accordance with one method 400 shown in FIG. 4, a maxel can be demagnetized by successively printing maxels having reversing polarity and decreasing field strength at the same location. At step 402, the demagnetizing process is started. At step 404, establish first magnetizing polarity. At step 406, establish first magnetizing field strength. At step 408, move material and/or magnetizing coil to location coordinate for demagnetization. At step 410, magnetize maxel with established magnetizing field having established magnetic field strength. At step 412, determine if region has been demagnetized. If result of step 412 is no, then at step 414 reverse established magnetizing polarity and decrease established magnetizing field strength then return to step 410. If result of step 412 is yes, then at step 416 stop the demagnetizing process.

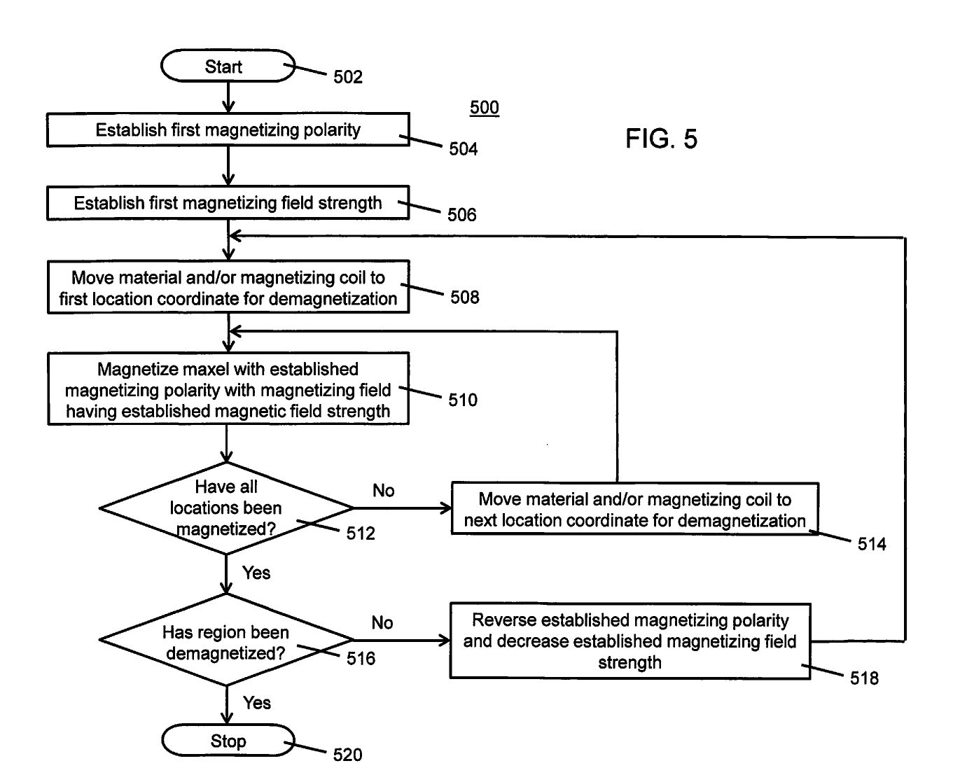

In accordance with another demagnetizing method 500 shown in FIG. 5, the demagnetization of a region can involve magnetization of an entire region by printing a plurality of maxels of the same polarity and field strength over the region, rewriting the region with opposite polarity maxels having a lesser field strength, and repeating the previous two steps until the region is demagnetized. At step 502, the demagnetizing process is started. At step 504, establish first magnetizing polarity. At step 506, establish first magnetizing field strength. At step 508, move material and/or magnetizing coil to first location coordinate for demagnetization. At step 510, magnetize maxel with established magnetizing polarity with magnetizing field having established magnetic field strength. At step 512, determine if all locations have been demagnetized. If result of step 512 is no, then at step 514 move material and/or magnetizing coil to next location coordinate for demagnetization and then return to step 510. If result of step 512 is yes, then at step 516 determine if region has been demagnetized. If result of step 516 is no, then at step 518 reverse established magnetizing polarity and decrease established magnetizing field strength then return to step 508. If result of step 516 is yes, then at step 520 stop the demagnetizing process.

Yet another demagnetizing method 600 is shown in FIG. 6, this demagnetizing method 600 involves demagnetizing a region by demagnetizing each maxel location one at a time. At step 602, the demagnetizing process is started. At step 604, establish first magnetizing polarity. At step 606, establish first magnetizing field strength. At step 608, move material and/or magnetizing coil to first location coordinate for demagnetization. At step 610, magnetize maxel with established magnetizing polarity with magnetizing field having established magnetic field strength. At step 612, determine if region has been demagnetized. If result of step 612 is no, then at step 614 reverse established magnetizing polarity and decrease established magnetizing field strength then return to step 610. If result of step 612 is yes, then at step 616 determine if all locations have been demagnetized. If result of step 616 is no, then at step 618 move material and/or magnetizing coil to next location coordinate for demagnetization and then return to step 604. If result of step 616 is yes, then at step 620 stop the demagnetizing process.

In accordance with the invention, a material can be demagnetized on one side and then demagnetized on the other, or both sides may be demagnetized at the same time. Under another arrangement, only one side may be demagnetized. The depth of demagnetization may or may not correspond to the depth that a material was previously magnetized. Demagnetization can involve printing maxels of alternating polarity with a different magnetization direction then a material was originally magnetized.

In accordance with the invention, maxels of a given polarity may overwrite a given region a plurality of times before the polarity of the overwriting maxels is changed. The maxels of the given polarity may be printed by the same print head or multiple print heads as necessary to efficiently overwrite the region.

A region to be demagnetized may correspond to an outer boundary of a material such as depicted in FIGS. 3A-3D, which might be done to limit side interaction between two magnetic structures in which case the width of the demagnetized region can be selected to achieve a desired minimum attractive force between the two structures. A region may be internal to the structure.

More generally, demagnetization of a region in accordance with the invention does not have to be complete demagnetization. Instead, the demagnetization process may be used to partially magnetize so as to lower the field strength of a given region. As such, the present invention enables a way of weakening a maxel or a group of maxels.

Demagnetization in accordance with the invention can enable conveyance of information, where a sensor can detect demagnetized regions, which can be in accordance with a predefined pattern corresponding to the information.

While particular embodiments of the invention have been described, it will be understood, however, that the invention is not limited thereto, since modifications may be made by those skilled in the art, particularly in light of the foregoing teachings.

1. A system for demagnetizing a region of a magnetic structure, the system comprising:
a pulsed magnetizer; and
at least one magnetizing coil that receives a sequence of discrete currents with continually decreasing current values from the pulsed magnetizer and outputs a sequence of discrete magnetizing fields with continually decreasing field strengths to overwrite and at least partly demagnetize the region of the magnetic structure, and wherein the at least one magnetizing coil is located adjacent to the region of the magnetic structure.

2. The system of claim 1, wherein the at least one magnetizing coil receives the sequence of discrete currents with continually decreasing current values from the pulsed magnetizer and outputs the sequence of discrete magnetizing fields with the continually decreasing field strengths and alternating polarities to overwrite and at least partly demagnetize the region of the magnetic structure.

3. The system of claim 1, wherein the at least one magnetizing coil receives the sequence of discrete currents with continually decreasing current values from the pulsed magnetizer and outputs a first portion of the sequence of discrete magnetizing fields with the continually decreasing field strengths and a first polarity and then outputs a second portion of the sequence of discrete magnetizing fields with the continually decreasing field strengths and a second polarity to overwrite and at least partly demagnetize the region of the magnetic structure.

4. The system of claim 1, wherein the region comprises at least one maxel having a first polarity and at least one maxel having a second polarity.

5. The system of claim 1, wherein each maxel has a size, shape, depth, polarity, field strength, and angle relative to a surface of the magnetic structure.

6. The system of claim 1, wherein each magnetizing coil has a metal type, layer thickness, number of turns, aperture width, coil width, coil shape, and aperture shape.

7. The system of claim 1, wherein the continually decreasing field strengths decrease with a predetermined decrement pattern.

8. The system of claim 1, wherein the continually decreasing field strengths have a starting field strength selected based on a field strength of the region of the magnetic structure as determined prior to demagnetization.

9. The system of claim 8, wherein if partial demagnetization of the region on the magnetic structure is desired then the starting field strength selected is substantially lower than the field strength of the region of the magnetic structure as determined prior to demagnetization.

10. The system of claim 1, wherein the continually decreasing field strength have a starting field strength selected based on material characteristics of the magnetic structure.

11. The system of claim 1, wherein the at least one magnetizing coil is at least one movable magnetizing coil.

12. A method for demagnetizing a region of a magnetic structure, the method comprising:
generating, by a pulsed magnetizer, a sequence of discrete currents with continually decreasing current values;
receiving, by at least one magnetizing coil, the sequence of discrete currents with continually decreasing current values; and
outputting, by the at least one magnetizing coil, a sequence of discrete magnetizing fields with continually decreasing field strengths to overwrite and at least partly demagnetize the region of the magnetic structure, and wherein the at least one magnetizing coil is located adjacent to the region of the magnetic structure.

13. The method of claim 12, wherein the at least one magnetizing coil receives the sequence of discrete currents with continually decreasing current values from the pulsed magnetizer and outputs the sequence of discrete magnetizing fields with the continually decreasing field strengths and alternating polarities to overwrite and at least partly demagnetize the region of the magnetic structure.

14. The method of claim 12, wherein the at least one magnetizing coil receives the sequence of discrete currents with continually decreasing current values from the pulsed magnetizer and outputs a first portion of the sequence of discrete magnetizing fields with the continually decreasing field strengths and a first polarity and then outputs a second portion of the sequence of discrete magnetizing fields with the continually decreasing field strengths and a second polarity to overwrite and at least partly demagnetize the region of the magnetic structure.

15. The method of claim 12, wherein the region comprises at least one maxel having a first polarity and at least one maxel having a second polarity.

16. The method of claim 12, wherein each maxel has a size, shape, depth, polarity, field strength, and angle relative to a surface of the magnetic structure.

17. The method of claim 12, wherein each magnetizing coil has a metal type, layer thickness, number of turns, aperture width, coil width, coil shape, and aperture shape.

18. The method of claim 12, wherein the continually decreasing field strengths decrease with a predetermined decrement pattern.

19. The method of claim 12, wherein the continually decreasing field strengths have a starting field strength selected based on a field strength of the region of the magnetic structure as determined prior to demagnetization.

20. The method of claim 19, wherein if partial demagnetization of the region on the magnetic structure is desired then the starting field strength selected is substantially lower than the field strength of the region of the magnetic structure as determined prior to demagnetization.

21. The method of claim 12, wherein the continually decreasing field strength have a starting field strength selected based on material characteristics of the magnetic structure.

22. The method of claim 12, wherein the at least one magnetizing coil is at least one movable magnetizing coil.
